(19) United States
(12) Patent Application Publication
(10) Pub. No.: US 2021/0271154 A1
(43) Pub. Date: Sep. 2, 2021

(54) CAMERA MODULE WITH IMPROVED HEAT DISSIPATION AND ELECTRONIC DEVICE USING THE SAME

(71) Applicant: TRIPLE WIN TECHNOLOGY(SHENZHEN) CO.LTD., Shenzhen (CN)

(72) Inventors: SHENG-JIE DING, Shenzhen (CN); SHIN-WEN CHEN, Tu-Cheng (TW); JING-WEI LI, Shenzhen (CN); JIAN-CHAO SONG, Shenzhen (CN); XIAO-MEI MA, Shenzhen (CN)

(21) Appl. No.: 17/027,920

(22) Filed: Sep. 22, 2020

(30) Foreign Application Priority Data
Mar. 2, 2020 (CN) 202020240119.7

(51) Int. Cl. G03B 17/55; H04N 5/225; H04M 1/02

(52) U.S. Cl. CPC G03B 17/55; H04M 1/0264; H04N 5/2254; H04N 5/2252

(57) ABSTRACT

A camera module with heat-dissipating structure includes a substrate, a cooling plate, a chip and a lens assembly. The substrate includes an upper surface, a lower surface opposite to the upper surface, and an opening. The opening penetrates the upper surface and the lower surface. The cooling plate is disposed on the lower surface and covered the opening. A portion of the cooling plate is exposed from the opening. A surface of the cooling plate facing away from the substrate forms a plurality of protrusions. The chip is disposed on the portion of the cooling plate exposed from the upper surface. The lens assembly is disposed on the upper surface and faces the chip. An electronic device using the module is also disclosed.

### FIELD

The disclosure generally relates to temperature control, a camera module and an electronic device using the same.

### BACKGROUND

Electronic devices, such as mobile phones or tablet computers, may include camera modules. In order to prevent dust, moisture and other impurities from entering camera module, the camera module is sealed to protect the base, the lens, and the circuit board in the camera module. During operation, the camera module generates a large amount of heat. Heat accumulating inside the camera module may destroy the internal structure of the camera module and affect normal operation of the camera module.

### BRIEF DESCRIPTION OF THE FIGURES

Implementations of the present disclosure will now be described, by way of example only, with reference to the attached figures.

FIG. 1 is a block diagram of an embodiment of an electronic device.

FIG. 2 is a perspective view of an embodiment of a camera module.

FIG. 3 is an exploded view of the camera module in FIG. 2.

FIG. 4 is an exploded view of a lens assembly of the camera module in FIG. 2.

FIG. 5 is an exploded view of a portion of the camera module in FIG. 2.

FIG. 6 is an exploded view of a portion of the camera module in FIG. 2 from another angle.

FIG. 7 is a cross-sectional view of the camera module in FIG. 2.

FIG. 8A is a perspective view of an embodiment of a cooling plate.

FIG. 8B is a cross-sectional view of the cooling plate in FIG. 8A.

FIG. 9A is a perspective view of another embodiment of a cooling plate.

FIG. 9B is a cross-sectional view of the cooling plate in FIG. 9A.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but is not limited thereto”; it specifically indicates open-ended inclusion or membership in the so-described combination, group, series and the like. The term “coupled” when utilized, means “a direct connection between the things that are connected, or an indirect connection through one or more passive or active intermediary devices, but is not limited thereto”.

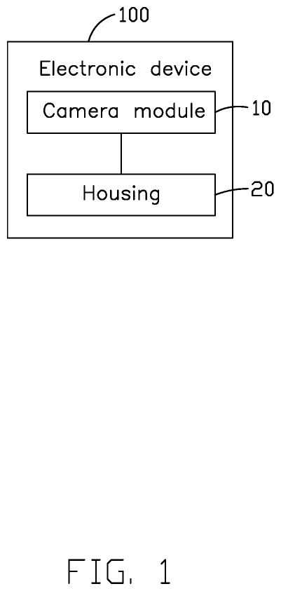

FIG. 1 illustrates an embodiment of an electronic device 100. The electronic device 100 may be a tablet computer, a mobile phone, or other device with a camera module 10. The electronic device 100 further includes a housing 20. The camera module 10 is received in the housing 20. In other embodiments, the electronic device 100 further includes other electronic components. The electronic components may be, but are not limited to, batteries, display panels, and processors.

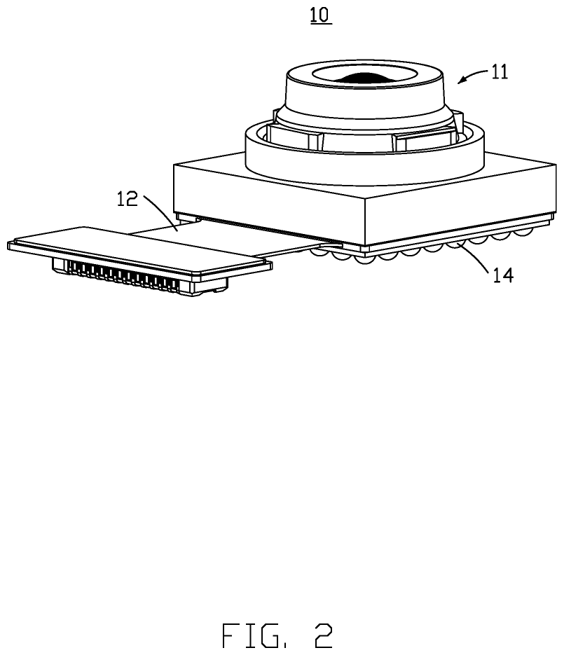

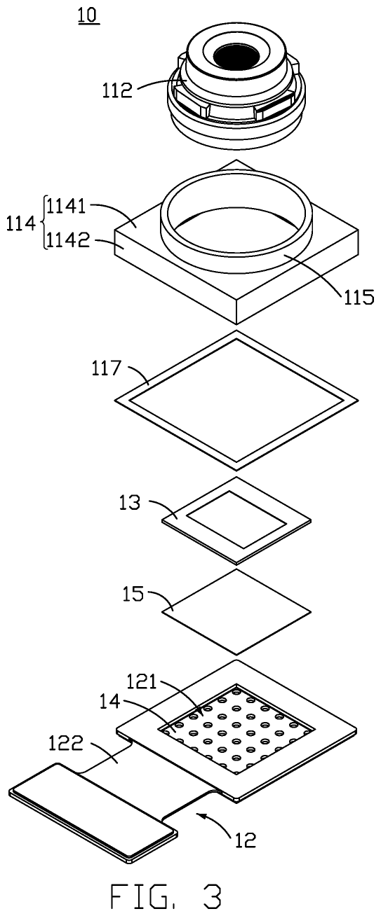

Referring to FIGS. 2 and 3, the camera module 10 includes a lens assembly 11, a substrate 12, a chip 13, and a cooling plate 14.

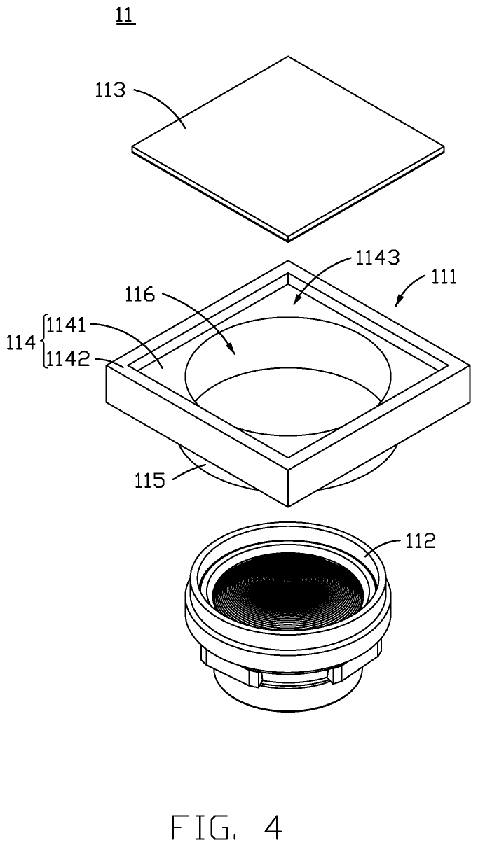

In at least one embodiment, referring to FIGS. 2 and 4, the lens assembly 11 is disposed on the substrate 12. The lens assembly 11 includes a lens holder 111, a lens 112, and an optical filter 113.

Referring to FIG. 3, the lens holder 111 includes a first portion 114 and a second portion 115. The second portion 115 is disposed on the first portion 114. In at least one embodiment, the first portion 114 and the second portion 115 are integrally formed. In other embodiments, the first portion 114 and the second portion 115 can also be assembled together.

Referring to FIGS. 3 and 4, the first portion 114 includes a top wall 1141 and a peripheral wall 1142. The peripheral wall 1142 is disposed around a periphery of the top wall 1141. The peripheral wall 1142 and the top wall 1141 cooperatively form a receiving space 1143. A surface of the peripheral wall 1142 facing away from the top wall 1141 is disposed on the substrate 12. An adhesive layer 117 is further disposed between the peripheral wall 1142 and the substrate 12. The adhesive layer 117 fixes the lens holder 111 to the substrate 12. In at least one embodiment, the adhesive layer 117 may be, but is not limited to, glue or gummed paper.

In at least one embodiment, the top wall 1141 is rectangular. In other embodiments, the shape of the top wall 1141 may be circular, triangular, or trapezoidal. The shape of the peripheral wall 1142 may be adjusted according to the shape of the top wall 1141.

Referring to FIGS. 3 and 4, the second portion 115 is disposed on a surface of the top wall 1141 facing away from the peripheral wall 1142. In at least one embodiment, the lens holder 111 defines a through hole 116. The through hole 116 penetrates the second portion 115 and the top wall 1141. The through hole 116 is connected to the receiving space 1143. The second portion 115 is annular. In other embodiments, the second portion 115 may be a rectangular ring according to needs.

The lens 112 is received in the through hole 116. The optical filter 113 is received in the receiving space 1143. In at least one embodiment, the optical filter 113 is disposed on a surface of the top wall 1141 facing away from the lens 112 and covers the through hole 116. The optical filter 113 filters light, such as ultraviolet light or infrared light entering the lens 112. In one embodiment, the optical filter 113 may be selected from a blue glass or IR glass. The optical filter 113 may be fixed to the top wall 1141 by glue or gummed paper.

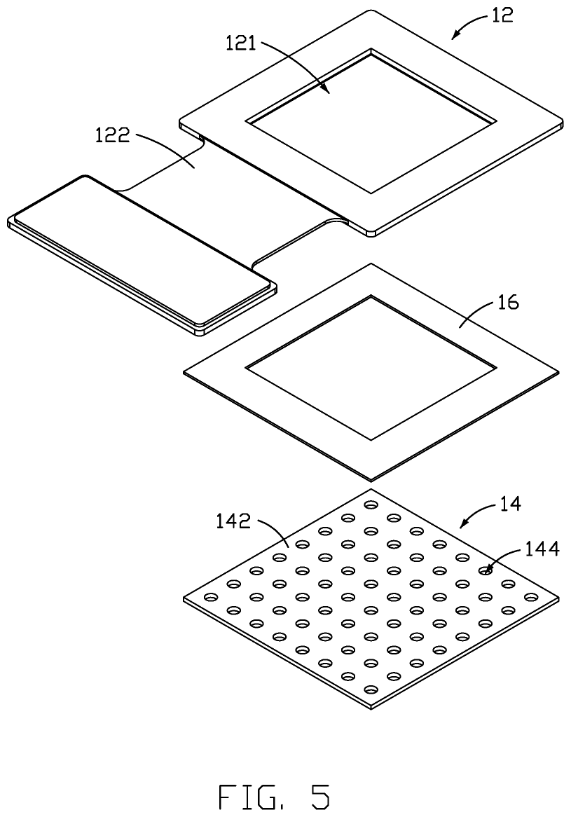

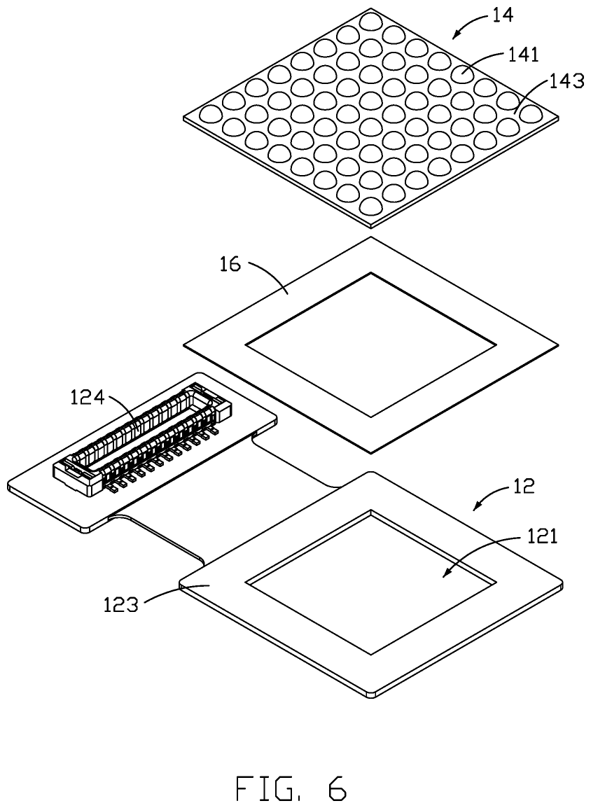

Referring to FIGS. 5 and 6, the substrate 12 defines an opening 121. In at least one embodiment, the substrate 12 includes an upper surface 122 and a lower surface 123 opposite to the upper surface 122. The bottom surface 123 faces away from the lens assembly 11. The opening 121 penetrates the upper surface 122 and the lower surface 123. When the first portion 114 of the lens holder 111 is disposed on the upper surface 122 of the substrate 12, the opening 121 is covered by the first portion 114 (shown in FIGS. 2 and 3), and the opening 121 is connected to the receiving space 1143.

In at least one embodiment, referring to FIG. 6, an electronic connector 124 is disposed on the lower surface 123 of the substrate 12. The electrical connector 124 is electrically connected to the lens assembly 11. When the camera module 10 is installed in the electronic device 100, the electrical connector 124 is electrically connected to other electronic components in the electronic device 100, so as to realize signal transmission between the camera module 10 and the electronic components in the electronic device 100. The electrical connector 124 may be an edge connector or a connecting finger.

Referring to FIGS. 3 and 6, the cooling plate 14 is disposed on the lower surface 123 of the substrate 12 and covers the opening 121. A portion of the cooling plate 14 is exposed from the opening 121. The chip 13 is disposed on the portion of the cooling plate 14 exposed from the opening 121. The heat generated by the chip 13 is transferred to the outside through the cooling plate 14, preventing the heat from affecting the imaging quality of the camera module 10.

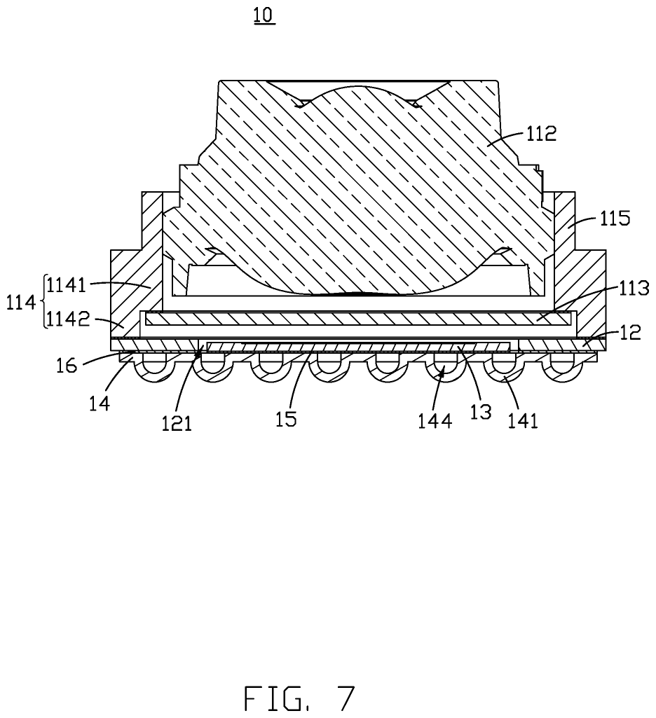

Referring to FIGS. 6 and 7, a plurality of protrusions 141 are formed on a surface of the cooling plate 14 facing away from the chip 13. The protrusions 141 assist the circulation of air. When the heat generated by the chip 13 is transferred to the protrusions 141, the heat is transferred to the outside by the circulation of air, speeding up the heat dissipation of the camera module 10. In addition, the protrusions 141 increases surface area of the cooling plate 14, thereby improving the heat dissipation efficiency of the cooling plate 14.

Referring to FIGS. 5 and 6, the cooling plate 14 includes an inner surface 142 and an outer surface 143 opposite to the inner surface 142. The outer surface 143 faces away from the lens assembly 11. The protrusions 141 are formed on the outer surface 143, and grooves 144 are formed on the inner surface 142 corresponding to the protrusions 141. In at least one embodiment, the cooling plate 14 is a metal plate. The metal plate is rigid and flat and not easily deformed when heated, thus preventing deviation of the chip 13 from being from an optical axis of the lens 112 due to the deformation. The imaging quality of the camera module 10 is thus maintained. In addition, since the metal plate has high mechanical strength, drop resistance of the camera module 10 is improved, and the reliability of the chip 13 enhanced.

In at least one embodiment, the protrusions 141 may be formed when the cooling plate 14 is die-cast. The metal plate may be selected from steel plate, aluminum alloy plate, copper alloy plate, or iron alloy plate. In other embodiments, the protrusions 141 may be formed by punching the inner surface 142 of the cooling plate 14.

In at least one embodiment, a longitudinal cross-section of the protrusions 141 may be fan-shaped, rectangular, or trapezoidal.

### Embodiment 1

Referring to FIGS. 5 and 6, the shape of the cooling plate 14 is rectangular. In Embodiment 1, protrusions 141 are formed on the cooling plate 14. The protrusions 141 are arranged in a matrix.

In Embodiment 1, the protrusions 141 are arranged in an array of 8 rows and 8 columns. In other embodiments, the number and the arrangement of the protrusions 141 can be adjusted according to the length and the width of the cooling plate 14.

In Embodiment 1, referring to FIG. 7, a longitudinal cross-section of each protrusion 141 is fan-shaped.

### Embodiment 2

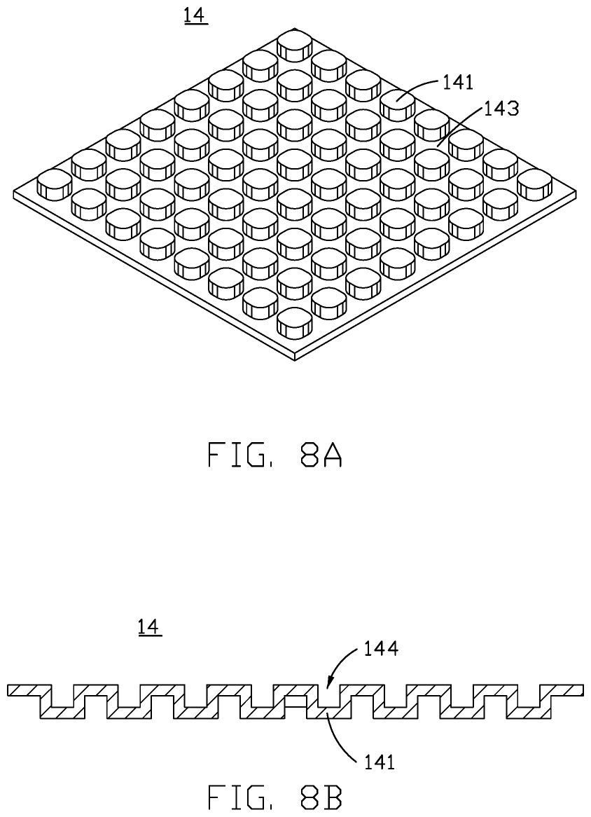

Referring to FIGS. 8A and 8B, the difference between Embodiment 2 and Embodiment 1 is that the longitudinal cross-section of the protrusions 141 is rectangular.

### Embodiment 3

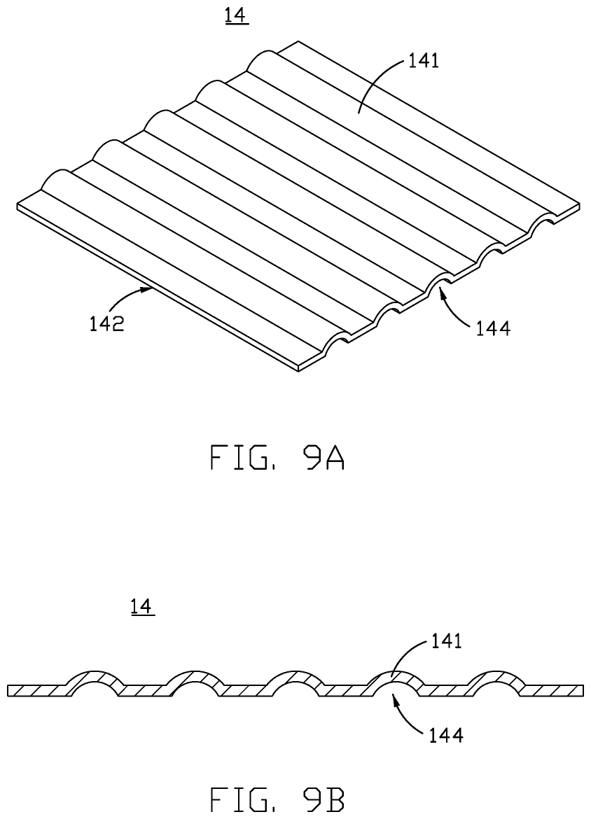

Referring to FIGS. 9A and 9B, the shape of the cooling plate 14 is rectangular. In Embodiment 3, protrusions 141 are formed on the cooling plate 14. Each protrusion 141 is a long strip. The protrusions 141 are parallel to each other.

In Embodiment 3, five protrusions 141 are formed on the cooling plate 14. In other embodiments, the number of the protrusions 141 can be adjusted according to the length and the width of the cooling plate 14.

In Embodiment 3, the longitudinal cross-section of the protrusion 141 is trapezoidal.

Referring to FIGS. 3, 5, and 6, the camera module 10 further includes a first connecting member 15 and a second connecting member 16. The first connecting member 15 is disposed between the chip 13 and the cooling plate 14 to fix the chip 13 to the cooling plate 14. The second connecting member 16 is disposed between the cooling plate 14 and the substrate 12 to fix the cooling plate 14 to the substrate 12.

In at least one embodiment, the first connecting member 15 may be made of a heat-conducting adhesive, and the second connecting member 16 also made of the heat-conducting adhesive. In this way, heat generated by the chip 13 passes through the first connecting member 15 and the second connecting member 16 and is transferred to the cooling plate 14.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A camera module, comprising:
a substrate comprising:
an upper surface and a lower surface opposite to the upper surface; and
an opening penetrated the upper surface and the lower surface;
a cooling plate disposed on the lower surface and covering the opening, wherein a portion of the cooling plate is exposed from the opening, a surface of the cooling plate facing away from the substrate forms a plurality of protrusions;
a chip disposed on the portion of the cooling plate exposed from the opening; and
a lens assembly disposed on the upper surface and faces the chip.

2. The camera module of claim 1, wherein the cooling plate comprises an inner surface and an outer surface opposite to the inner surface, the inner surface faces the substrate, the plurality of protrusions is formed on the outer surface, and the inner surface forms a plurality of grooves corresponding to the plurality of protrusions.

3. The camera module of claim 1, wherein the plurality of protrusions is arranged in a matrix.

4. The camera module of claim 1, wherein a longitudinal cross-section of each protrusion is fan-shaped, rectangular, or trapezoidal.

5. The camera module of claim 1, wherein each of the plurality of protrusions is a long strip, and the plurality of protrusions is parallel to each other.

6. The camera module of claim 1, wherein the cooling plate is made of steel, aluminum alloy, or copper.

7. The camera module of claim 2, wherein the camera module comprises a first connecting member, and the first connecting member is disposed between the chip and the cooling plate.

8. The camera module of claim 7, wherein the camera module comprises a second connecting member, and the second connecting member is disposed between the substrate and the cooling plate.

9. The camera module of claim 8, wherein the first connecting member and the second connecting member are made of heat-conducting adhesive.

10. An electronic device comprising:
a housing, and
a camera module disposed in the housing, the camera module comprising:
a substrate comprising:
an upper surface and a lower surface opposite to the upper surface; and
an opening penetrated the upper surface and the lower surface;
a cooling plate disposed on the lower surface and covering the opening, wherein a portion of the cooling plate is exposed from the opening, a surface of the cooling plate facing away from the substrate forms a plurality of protrusions;
a chip disposed on the portion of the cooling plate which exposed from the opening; and
a lens assembly disposed on the upper surface and faces the chip.

11. The electronic device of claim 10, wherein the cooling plate comprises an inner surface and an outer surface opposite to the inner surface, the inner surface faces the substrate, the plurality of protrusions is formed on the outer surface, and the inner surface forms a plurality of grooves corresponding to the plurality of protrusion.

12. The electronic device of claim 10, wherein the plurality of protrusions is arranged in a matrix.

13. The electronic device of claim 10, wherein a longitudinal cross-section of each protrusion is fan-shaped, rectangular, or trapezoidal.

14. The electronic device of claim 10, wherein of the plurality of protrusion is a long strip, and the plurality of protrusions is parallel to each other.

15. The electronic device of claim 10, wherein the cooling plate is made steel, aluminum alloy, or copper alloy.

16. The electronic device of claim 11, wherein the camera module comprises a first connecting member, and the first connecting member is disposed between the chip and the cooling plate.

17. The electronic device of claim 16, wherein the camera module comprises a second connecting member, and the second connecting member is disposed between the substrate and the cooling plate.

18. The electronic device of claim 17, wherein the first connecting member and the second connecting member are made of heat-conducting adhesive.
